(19) United States
(12) Patent Application Publication
(10) Pub. No.: US 2003/0137833 A1
(43) Pub. Date: Jul. 24, 2003

(54) Mini flashlight

(76) Inventor: Cheng-Chien Hsu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/052,541

(22) Filed: Jan. 23, 2002

(51) Int. Cl. F21L 4/00

(52) U.S. Cl. 362/196; 362/116; 362/189; 362/201

(57) ABSTRACT

A mini flashlight formed of a bottom cover shell, a top cover shell, a LED, and a battery set. The bottom cover shell has a frame for supporting the battery set and holding the negative pole lead-out leg of the LED in close contact with the negative terminal of the battery set, and a fence for supporting the positive pole lead-out leg of the LED above the positive terminal of the battery set. The top cover shell has an oval convex middle part surrounded by an endless groove with a center finger recess for pressing with the thumb to force the positive pole lead-out leg of the LED into contact with the positive terminal of the battery set.

### BACKGROUND OF THE INVENTION

1. Field of the Invention

The present invention relates to a mini flashlight and, more particularly, to an improved structure of mini flashlight.

2. Description of the Related Art

A variety of key ring-incorporated mini flashlights are well known. FIG. 7 shows a conventional press switch type mini flashlight. According to this design, the mini flashlight A has a press switch 11 controlled to switch on/off the LED (light emitting diode) 12. This design of mini flashlight A is not satisfactory in function. When the applied force deviated from the center area of the press switch 11 or not evenly employed to the press switch 11, the LED 12 may flash, or not be turned on. FIG. 8 shows a conventional slide switch type mini flashlight. According to this design, the mini flashlight B has a slide switch 13 moved back and forth to switch on/off the LED 12. This design of mini flashlight is not durable in use because the slide switch 13 wears quickly with use.

FIGS. from 9 through 12 show a mini flashlight constructed according to Taiwan patent publication no. 361118. According to this design, the mini flashlight C is comprised of a casing 14, a LED 15, two battery cells 16, and a metal contact strip 17. The casing 14 is comprised of two shells, namely, the top cover shell and the bottom cover shell that are hinged together. The metal contact strip 17 connects the battery cells 16 in series. The two lead-out legs 151 of the LED 15 are respectively suspended above the battery cells 16. When the user pressed the top cover shell of the casing 14 with the thumb, the lead-out legs 151 of the LED 15 are forced into contact with the battery cells 16 to close the circuit, and therefore the LED 15 is turned on to emit light. When the user released the thumb from the top cover shell of the casing 14, the LED 15 is off. This design of mini flashlight is still not satisfactory in function. When the user carries the mini flashlight C in the pocket or the bag, the top cover shell of the casing 14 tends to be forced against the lead-out legs 151 of the LED 15 by an external pressure, thereby causing the LED 15 to consume the power of the battery cells 16.

FIGS. 13 and 14 show still another prior art design under US2001/0038534A1, issued on Nov. 8, 2001, entitled “MINIATURE FLASHLIGHT”. This design of mini flashlight D is similar to the aforesaid Taiwan patent publication no. 361118, comprised of a top cover shell 18, a bottom cover shell 19, a LED 20, a metal contact strip 21, and two battery cells 22. The lead-out legs 201 and 202 of the LED 20 have different lengths. The battery cells 22 are arranged in a stack and supported on the long lead-out leg 201 of the LED 20 inside the bottom cover shell 19. The metal contact strip 21 is mounted in the top cover shell 18 and disposed above the short lead-out leg 202 of the LED 20 and the battery cells 22. When the user pressed the top cover shell 18 against the bottom cover shell 19 by hand, the metal contact strip 21 is forced into contact with the battery cells 22 and the short lead-out leg 202 of the LED 20 to close the circuit of the LED 20 and the battery cells 22, thereby causing the LED 20 to emit light. This design cannot eliminate the drawback of Taiwan patent publication no. 361118. The use of the metal contact strip 21 complicates the assembly process of the mini flashlight. The multiple contact points of the electric circuit of this design of mini flashlight may cause a contact error easily.

### SUMMARY OF THE INVENTION

The present invention has been accomplished to provide a mini flashlight, which eliminates the aforesaid drawbacks. It is one object of the present invention to provide a mini flashlight, which is easy to use. It is another object of the present invention to provide a mini flashlight, which prevents triggering accidentally. According to one aspect of the present invention, the mini flashlight comprises a bottom cover shell, a top cover shell, a LED, and a battery set. The bottom cover shell has a frame for supporting the battery set and holding the negative pole lead-out leg of the LED in close contact with the negative terminal of the battery set, and a fence for supporting the positive pole lead-out leg of the LED above the positive terminal of the battery set. The top cover shell has an oval convex middle part surrounded by an endless groove with a center finger recess for pressing with the thumb to force the positive pole lead-out leg of the LED into contact with the positive terminal of the battery set. According to another aspect of the present invention, the lead-out legs of the LED are curved in different directions so that the negative pole lead-out leg can be inserted through an opening of the fence and positively supported on a step of the frame and maintained in close contact with the negative terminal of the battery set, and the positive pole lead-out leg can be supported on a top protruded portion of the fence and maintained suspended above the positive terminal of the battery set below the finger recess of the top cover shell.

### BRIEF DESCRIPTION OF THE DRAWINGS

FIG. 1 is an elevational view of a mini flashlight according to the present invention.

FIG. 2 is an exploded view of the mini flashlight shown on FIG. 1.

FIG. 3 is an exploded view of a part of the present invention, showing the top cover shell separated from the bottom cover shell, the LED installed in the bottom cover shell.

FIG. 4 is an elevational view of a LED for the mini flashlight according to the present invention.

FIG. 5 is a sectional view of the present invention showing the off status of the mini flashlight.

FIG. 6 is a schematic drawing showing the thumb pressed on the finger recess of the top cover shell, the positive pole lead-out leg of the LED forced into contact with the positive terminal of the stack of battery cells.

FIG. 7 is an elevational view of a press switch type mini flashlight according to the prior art.

FIG. 8 is an elevational view of a slide switch type mini flashlight according to the prior art.

FIG. 9 is an exploded view of a mini flashlight according to Taiwan patent publication no. 361118.

FIG. 10 is an elevational assembly view of the mini flashlight shown on FIG. 9.

FIG. 11 is a sectional view of the mini flashlight shown on FIG. 10 when at “OFF” status.

FIG. 12 is a sectional view of the mini flashlight shown on FIG. 10 when at “ON” status.

FIG. 13 is an exploded view of the miniature flashlight according to US2001/0038534A1.

FIG. 14 is a sectional view of the miniature flashlight according to US2001/0038534A1.

### DETAILED DESCRIPTION OF THE PREFERRED EMBODIMENT

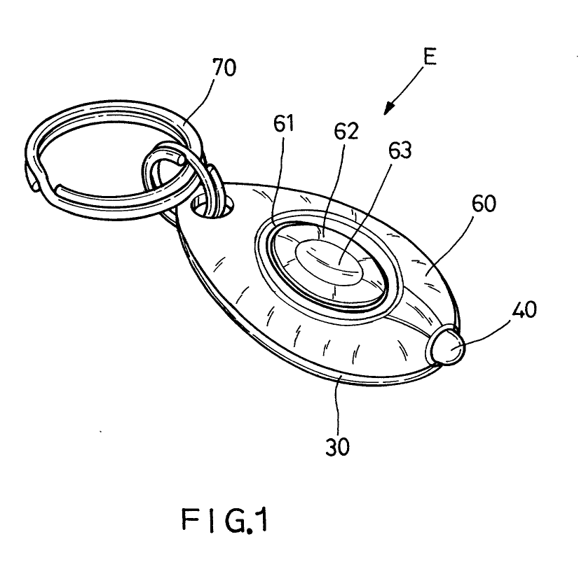

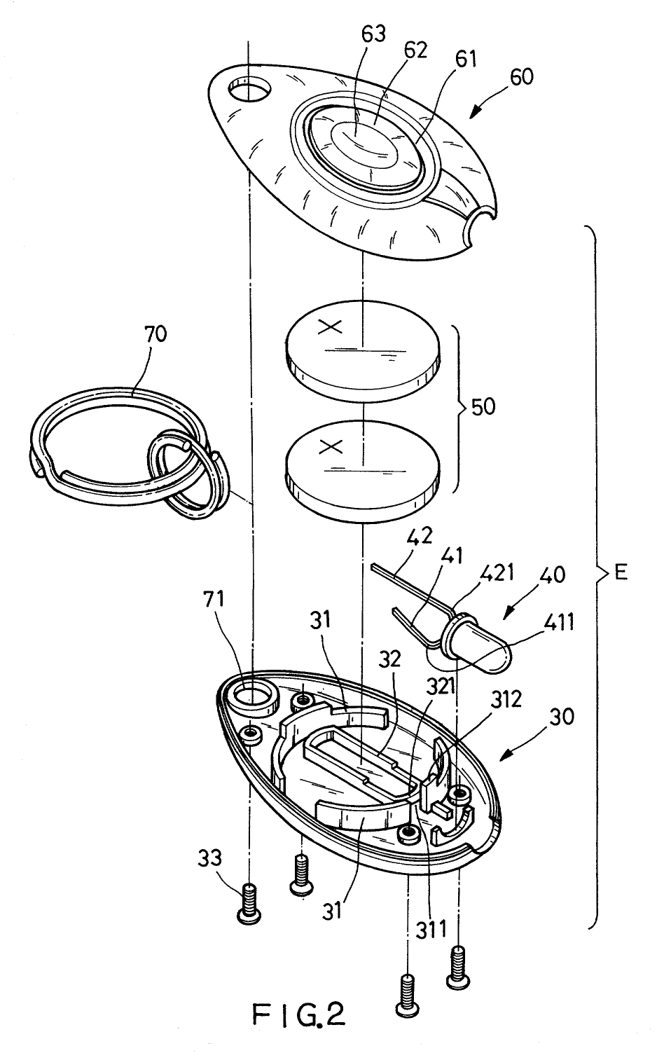

Referring to FIGS. 1 and 2, a mini flashlight E is shown comprised of a bottom cover shell 30, a LED (light emitting diode) 40, two battery cells 50, and a top cover shell 60.

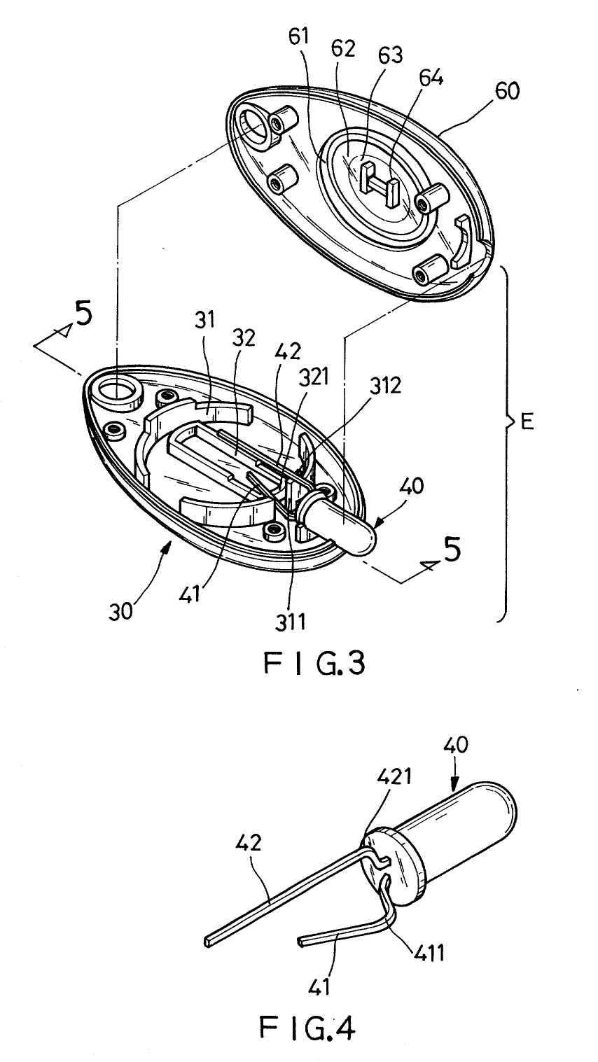

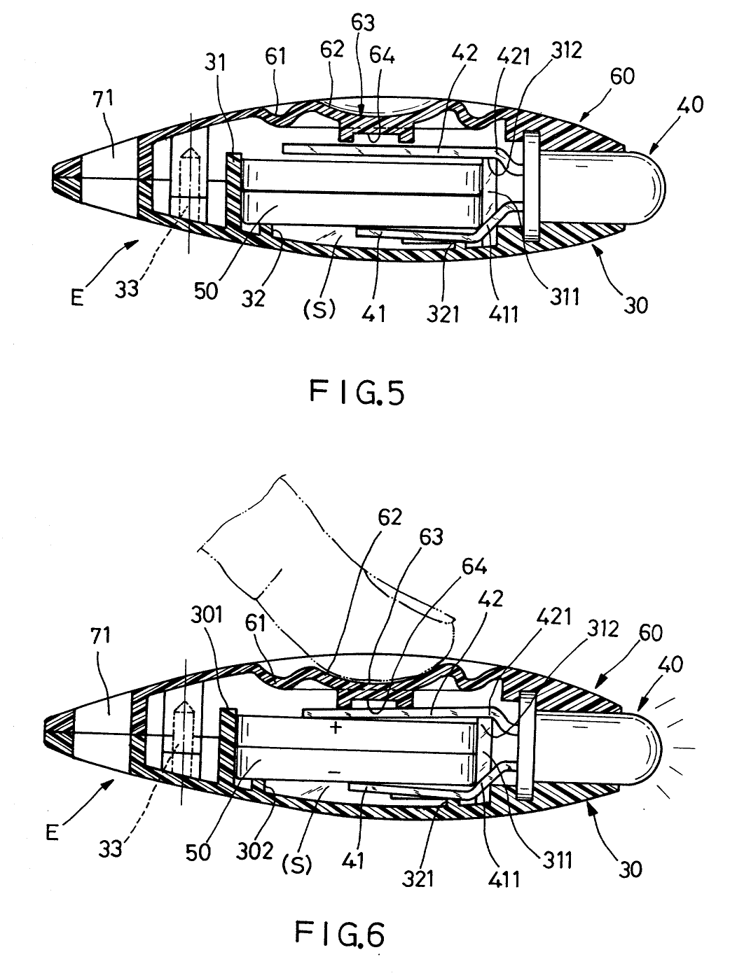

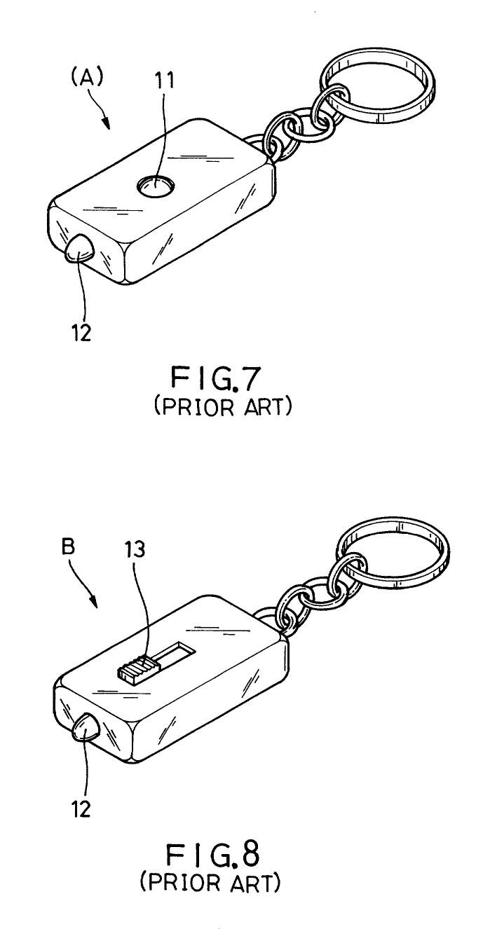

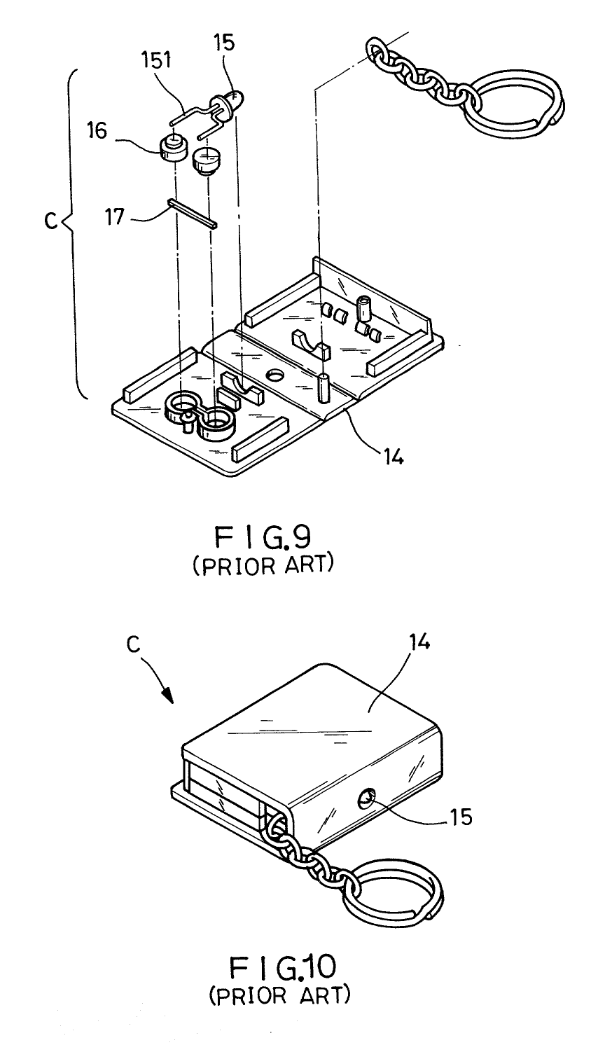

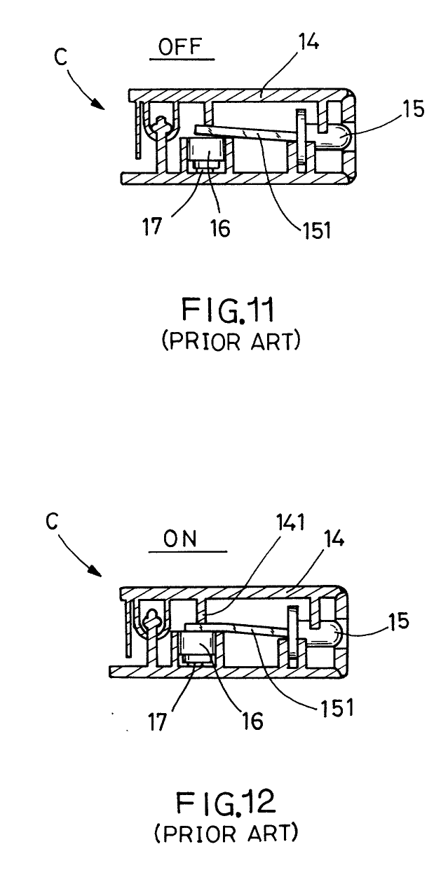

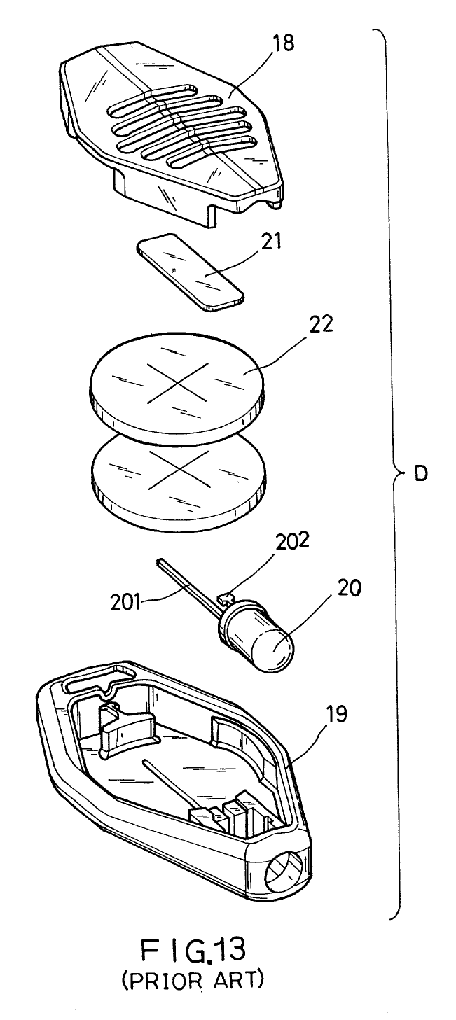

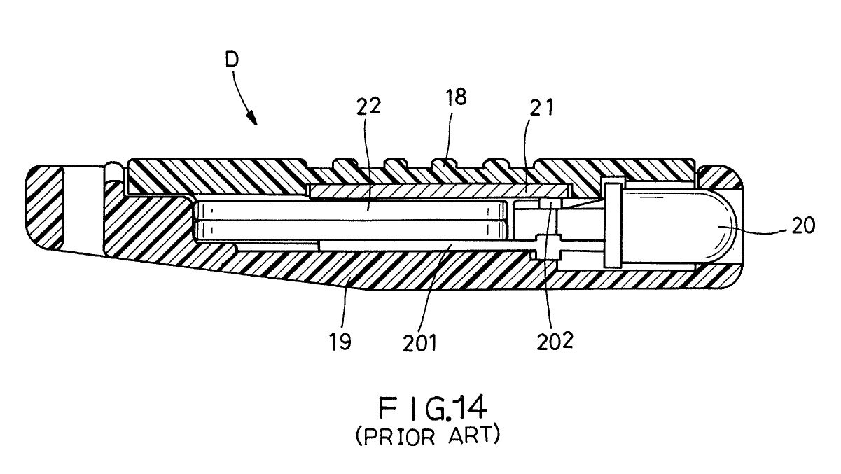

Referring to FIGS. from 3 through 5, the bottom cover shell 30 comprises a frame 32 disposed on the middle, the frame 32 having a front step 321 relatively lower than the topmost edge thereof, fence 31 disposed around the frame 32 and defining a circular battery positioning space. The battery cells 50 are arranged in a stack and supported on the frame 32 in the battery positioning space surrounded by the fence 31. After installation of the battery cells 50 in the bottom cover shell 30, a gap S is left between the bottom side (negative terminal) of the stack of battery cells 50 and the bottom wall of the bottom cover shell 30 (see FIG. 5). The LED 40 is mounted in the front side of the bottom cover shell 30, having a negative pole lead-out leg 41 extended over the front step 321 into the inside of the frame 32 (see FIG. 3) and maintained in close contact with the negative terminal of the stack of battery cells 50 (see FIG. 5), and a positive pole lead-out leg 42 suspended above the positive terminal of the stack of battery cells 50 (see FIG. 5).

Referring to FIGS. 2, 4, and 5 again, the negative pole lead-out leg 41 of the LED 40 has a curved front section 411 curving downwards and then obliquely upwards so that the negative pole lead-out leg 41 can be inserted through an opening 311 of the fence 31 and positively supported on the step 321 of the frame 32, keeping the end in close contact with the negative terminal of the stack of the battery cells 50. The positive pole lead-out leg 42 of the LED 40 has a curved front section 421 curving upwards and then horizontally forwards so that the positive pole lead-out leg 42 can be supported on a top protruded portion 312 of the fence 31, and maintained suspended above the positive terminal of the stack of battery cells 50.

Referring to FIGS. 2, 3, and 5 again, the top cover shell 60 is closed on the bottom cover shell 30 and fixedly secured thereby by screws 33 to hold down the LED 40, comprising an oval convex middle part 62, an endless groove 61 extended around the oval convex middle part 62, a finger recess 63 at the center of the top surface of the oval convex middle part 62, and a H-shaped rib 64 protruded from the bottom surface of the oval top protruding face 62 above the positive pole lead-out leg 42 of the LED 40.

Referring to FIGS. 1 and 2 again, the top cover shell 60 and the bottom cover shell 30 each have a mounting hole 71 disposed at one side, namely, the rear side remote from the LED 40 for the mounting of a key ring 70.

Referring to FIG. 5 again, normally, the negative pole lead-out leg 41 of the LED 40 is maintained in close contact with the negative terminal of the stack of battery cells 50, and the positive pole lead-out leg 42 is supported on the top protruded portion 312 of the fence 31 and maintained spaced above the positive terminal of the stack of battery cells 50 at the bottom side of the H-shaped rib 64 of the top cover shell 60, and therefore the LED 40 is off.

Referring to FIG. 6, when the user pressed the finger recess 63 with the thumb, the H-shaped rib 64 is lowered with the oval convex middle part 62 to force the positive pole lead-out leg 42 downwards into contact with the positive terminal of the stack of battery cells 50, thereby causing the LED 40 to be electrically connected to emit light. When the user released the thumb from the finger recess 63, the oval convex middle part 62 is immediately returns to its former position by the spring power of the material property of the top cover shell 60, and at the same time the metal spring power of the positive pole lead-out leg 42 of the LED 40 and the reactive force produced at the curved front section 421 return the positive pole lead-out leg 42 to its former position away from the positive terminal of the stack of battery cells 50, and therefore the LED 40 is off.

When the user carrying the mini flashlight E in the pocket, touching or squeezing the surface of the top cover shell 60 does not turn on the electric circuit of the LED 40 and the stack of battery cells 50, and the electric circuit of the LED 40 and the stack of battery cells 50 can be turned on only when a downward pressure is perpendicularly applied to the finger recess 63. Therefore, the invention prevents waste of battery power.

Furthermore, the top cover shell 60 is injection-molded from plastics. The presence of the endless groove 61 around the oval convex middle part 62 enables the oval convex middle part 62 to be easily curved downwards with the thumb and then immediately returned to its former position after removal of the thumb from the finger recess 63, preventing false action of the H-shaped rib 64 against the positive pole lead-out leg 42 of the LED 40.

A prototype of mini flashlight has been constructed with the features of the annexed drawings of FIGS. 1˜6. The mini flashlight functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A mini flashlight comprised of a bottom cover shell, a battery set mounted in said bottom cover shell, a LED (light emitting diode) mounted in said bottom cover shell, said LED having a negative pole lead-out leg disposed in contact with the negative terminal of said battery set and a positive pole lead-out leg spaced from the positive terminal of said battery set, and a top cover shell covering said bottom cover shell to hold down said LED and adapted for pressing by the user to force the positive pole lead-out leg of said LED into contact with the positive terminal of said battery set, wherein::
said bottom cover shell comprises a frame disposed on the middle and adapted for supporting said battery set, said frame having a front step adapted for supporting the negative pole lead-out leg of said LED, a fence disposed around said frame and defining a circular battery positioning space for receiving said battery set, said fence having an opening for the passing of the negative pole lead-out leg of said LED, and a top protruded portion for supporting the positive pole lead-out leg of said LED;
the negative pole lead-out leg of said LED has a curved front section curving downwards and then obliquely upwards for enabling the negative pole lead-out leg of said LED to be inserted through the opening of said fence and positively supported on the step of said frame and maintained in close contact with the negative terminal of said battery set;
the positive pole lead-out leg of said LED has a curved front section curving upwards and then horizontally forwards for enabling the positive pole lead-out leg of said LED to be supported on the top protruded portion of said fence and maintained suspended above the positive terminal of said battery set below said top cover shell;
said top cover shell comprises an oval convex middle part, an endless groove extended around said oval convex middle part, a finger recess at the center of a top surface of said oval convex middle part, and a H-shaped rib protruded from a bottom surface of said oval top protruding face above the positive pole lead-out leg of said LED for forcing said the positive pole lead-out leg of said LED into contact with the positive terminal of said battery set when the user pressed said finger recess with the thumb.

2. The mini flashlight as claimed in claim 1, wherein said top cover shell and said bottom cover shell each have a mounting hole for the mounting of a key ring.
